(19) United States
(12) Patent Application Publication
(10) Pub. No.: US 2013/0325164 A1
(43) Pub. Date: Dec. 5, 2013

(54) ELECTRIC DISCHARGE MACHINE AND ELECTRIC DISCHARGE MACHINING SYSTEM

(71) Applicants: Kotaro Wwatanabe, Chiyoda-ku (JP); Shingo Chida, Chiyoda-ku (JP)

(72) Inventors: Kotaro Wwatanabe, Chiyoda-ku (JP); Shingo Chida, Chiyoda-ku (JP)

(73) Assignee: MITSUBISHI ELECTRIC CORPORATION, Chiyoda-ku, Tokyo (JP)

(21) Appl. No.: 13/985,347

(22) PCT Filed: Feb. 24, 2011
(86) PCT No.: PCT/JP2011/054130

§ 371 Date: Aug. 14, 2013

(51) Int. Cl. G05B 19/18

(52) U.S. Cl. CPC G05B 19/18
USPC 700/180; 700/186

(57) ABSTRACT

To make corrections as effectively as possible according to an environmental temperature of an installation location, an electric discharge machine includes a temperature-displacement measurement unit that measures a transition of a displacement of a reference position and a transition of detected values of temperature sensors, a correction-coefficient calculation unit that calculates correction-coefficient calculated values based on a measurement result of the temperature/displacement measurement unit, a confirmation display unit that displays the measurement result of the temperature/displacement measurement unit and that prompts to input whether to use the correction-coefficient calculated values, and a change-agreement confirmation unit that updates correction-coefficient set values stored in a correction-coefficient set-value storage unit to the correction-coefficient calculated values when an input to an effect of using the correction-coefficient calculated values is received.

### FIELD

The present invention relates to an electric discharge machine and an electric discharge machining system that are capable of executing a positioning control over a machining position.

### BACKGROUND

Conventionally, there is known an electric discharge machine into which the following mechanism is incorporated. A temperature is measured using several temperature sensors so as to lessen the influence of the thermal displacement of a main spindle due to the temperature change of the surrounding environment on machining, corrected amounts are calculated by multiplying measured values by constant coefficients, and positioning correction is carried out. The coefficients used for this correction (correction coefficients) are normally fixed to certain values at the time of shipment based on the manufacturer's experiment.

However, the temperature environment under which the electric discharge machine is actually installed differs from the temperature environment of a location where a manufacturer conducted the experiment. Accordingly, the thermal-displacement correction coefficients at the time of the shipment from the manufacturer are not necessarily optimum for the actual installation environment. This causes a problem in that intended machining precision is not ensured.

To solve this problem, for example, Patent Literature 1 discloses a technique for associating corrected values or an integrated corrected value with the number of workpieces and an elapsed time, and obtaining and setting a corrected value from the number of workpieces and the elapsed time in relation to the current workpiece machining when a command to input the corrected value is issued. Furthermore, according to this technique, the temporal transition of the corrected value or that of the integrated corrected value can be graphically displayed so as to support the management of the corrected value.

### CITATION LIST

### Patent Literature

Patent Literature 1: Japanese Patent Application Laid-open No. 2004-30421

### SUMMARY

### Technical Problem

However, while the corrected value is calculated using the association of the corrected values or integrated corrected value with the number of workpieces and the elapsed time according to the technique of Patent Literature 1 mentioned above, the electric discharge machine needs to calculate the corrected value from the environmental temperature as described above. Therefore, it is not possible to calculate the corrected value simply using the technique of Patent Literature 1 mentioned above as it is.

The present invention has been achieved to solve the above problems, and an object of the present invention is to provide an electric discharge machine and an electric discharge machining system that are capable of making corrections as effectively as possible according to the environmental temperature of an installation location.

### Solution to Problem

To solve the above problems and achieve an object, there is provided an electric discharge machine according to the present invention that is capable of positioning-controlling a machining position, the electric discharge machine including: a temperature sensor that detects an environmental temperature; a command-value calculation unit that calculates a command value relating to the machining position; a set-value storage unit that stores therein a correction-coefficient set value; a command-value correction unit that estimates a displacement amount of a reference position based on a detected value of the temperature sensor and the correction-coefficient set value stored in the set-value storage unit, and that corrects the command value calculated by the command-value calculation unit using the estimated displacement amount; and a correction unit that corrects the correction-coefficient set value stored in the set-value storage unit, wherein the correction unit includes a measurement unit that measures a transition of the displacement amount of the reference position and a transition of the detected value of the temperature sensor, a correction-coefficient calculation unit that calculates a correction-coefficient calculated value based on a measurement result of the measurement unit, a confirmation display unit that displays the measurement result of the measurement unit and that prompts to input whether or not to use the correction-coefficient calculated value, and a setting change unit that updates the correction-coefficient set value stored in the set-value storage unit to the correction-coefficient calculated value when an input to an effect of using the correction-coefficient calculated value is received.

### Advantageous Effects of Invention

The electric discharge machine according to the present invention is configured to measure the transition of a displacement amount of a reference position and the transition of a detected value of a temperature sensor, to calculate a correction-coefficient calculated value based on a measurement result, and to display the measurement result and to prompt a user to input information as to whether to use the correction-coefficient calculated value. Therefore, it is possible to make corrections as effectively as possible according to the environmental temperature of an installation location.

### BRIEF DESCRIPTION OF DRAWINGS

FIG. 1 depicts a hardware configuration of an electric discharge machine according to a first embodiment.

FIG. 2-1 is an explanatory diagram of positioning of a columnar center.

FIG. 2-2 is an explanatory diagram of positioning of the columnar center.

FIG. 3 is an explanatory diagram of an example of a hardware configuration of a control device according to the first embodiment.

FIG. 4 is an explanatory diagram of a functional configuration of the control device according to the first embodiment.

FIG. 5 is an explanatory diagram of an example of displaying temperature measurement results.

FIG. 6 is an explanatory diagram of an example of displaying displacement measurement results.

FIG. 7 is an explanatory diagram of an example of displaying a comparison between respective correction effects.

FIG. 8 is a flowchart for explaining an operation performed by the electric discharge machine according to the first embodiment when electric discharge machining is performed.

FIG. 9 is a flowchart for explaining an operation performed by the electric discharge machine according to the first embodiment when correction coefficients are calculated.

FIG. 10 is a flowchart for explaining a temperature/displacement amount measurement process at Step S14 in more detail.

FIG. 11 is an explanatory diagram of a configuration of an electric discharge machining system according to a second embodiment.

FIG. 12 is an explanatory diagram of functional configurations of a control device and a server according to the second embodiment.

FIG. 13 is a list of extracted correction-coefficient set values.

FIG. 14-1 is a flowchart for explaining an operation performed by the electric discharge machining system according to the second embodiment when correction coefficients are calculated.

FIG. 14-2 is a flowchart for explaining an operation performed by the electric discharge machining system according to the second embodiment when correction coefficients are calculated.

FIG. 15 is an explanatory diagram of functional configurations of a control device and a server according to a third embodiment.

FIG. 16-1 is a flowchart for explaining an operation performed by an electric discharge machining system according to the third embodiment when correction coefficients are performed.

FIG. 16-2 is a flowchart for explaining an operation performed by the electric discharge machining system according to the third embodiment when correction coefficients are performed.

### DESCRIPTION OF EMBODIMENTS

Exemplary embodiments of an electric discharge machine and an electric discharge machining system according to the present invention will be explained below in detail with reference to the accompanying drawings. The present invention is not limited to the embodiments. While a die-sinking electric discharge machine is explained below as an example of the electric discharge machine, the present invention is applicable to any machining device as long as it is an electric discharge machine.

### First Embodiment

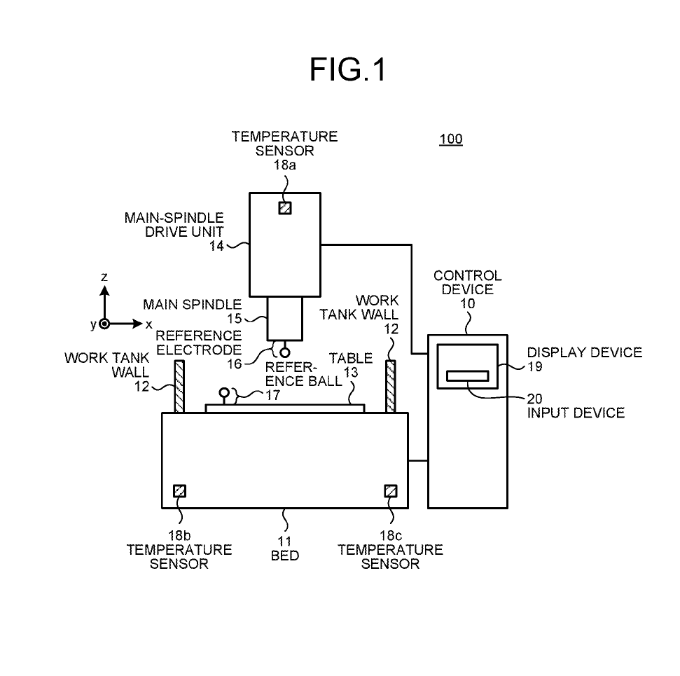

FIG. 1 depicts a hardware configuration of an electric discharge machine according to a first embodiment of the present invention. An electric discharge machine 100 includes a main spindle 15, a main-spindle drive unit 14 that holds the main spindle 15, a bed 11, and a table 13 fixed onto the bed 11. The main-spindle drive unit 14 includes a driving mechanism driven under a positioning control of a control device 10. Specifically, the main-spindle drive unit 14 moves an electrode fixed to the main spindle 15 vertically (in a z-axis direction), laterally (in an x-axis direction), and longitudinally (in a y-axis direction) relatively to the table 13 based on a position command value (hereinafter, simply “command value”) output from the control device 10. Work tank walls 12 are provided on the bed 11, and an upper surface of the bed 11 and the work tank walls 12 constitute a work tank filled with a working fluid.

The control device 10 not only functions as a numerical control device that positioning-controls the main spindle 15 but also executes a control over the entire electric discharge machine 100. The control device 10 includes a display device 19 displaying display information for a user and an input device 20 for receiving a user's operation input. In FIG. 1, the display device 19 is constituted by a touch panel and the input device 20 is constituted by a touch panel switch as an example. Alternatively, the display device 19 can be constituted by a CRT or an LCD and the input device 20 can be constituted by a hard switch, a keyboard, a pointing device or the like.

At a time of machining a workpiece, the user attaches an electrode (a machining electrode) for die-sinking electric discharge machining to the main spindle 15, locates the workpiece on the table 13, and generates electrohydraulic discharge between the machining electrode and the workpiece, thereby making it possible to machine the workpiece.

The electric discharge machine 100 also includes one or more temperature sensors (temperature sensors 18a, 18b, and 18c) detecting an environmental temperature of an installation environment. The control device 10 estimates a displacement amount of a reference (a reference position) for specifying a positional relation between the table 13 and the main spindle 15 due to a temperature change of the environmental temperature based on detected values of the temperature sensors 18a, 18b, and 18c and correction coefficients so as to correct the displacement amount, and corrects a command value to be output to the main-spindle drive unit 14 by the estimated displacement amount (that is, a corrected amount). It is assumed here that the corrected amount is obtained by multiplying the temperature sensors 18a to 18c by the correction coefficients although a relation between the correction coefficients and the corrected amount is not limited to any specific one.

As described above, even if the displacement amount is corrected using the manufacturer's set correction coefficients, the electric discharge machine 100 is unable to machine the workpiece with the intended machining precision if the environment at a time of manufacturer's calculating the correction coefficients differs from the environment under which the electric discharge machine 100 is installed. Therefore, in the first embodiment of the present invention, the electric discharge machine 100 is configured to be able to measure a transition of the temperature and a transition of the displacement amount of the reference position and to calculate correction coefficients having a greater correction effect based on a measurement result.

The displacement amount of the reference position (hereinafter, simply “displacement amount”) can be measured by a method for obtaining an origin of machine coordinates. Here, the displacement amount is obtained by executing positioning of a columnar center. In FIG. 1, a reference electrode 16 is attached to the main spindle 15 and a reference ball 17 is attached to the table 13 so as to execute the positioning of a columnar center.

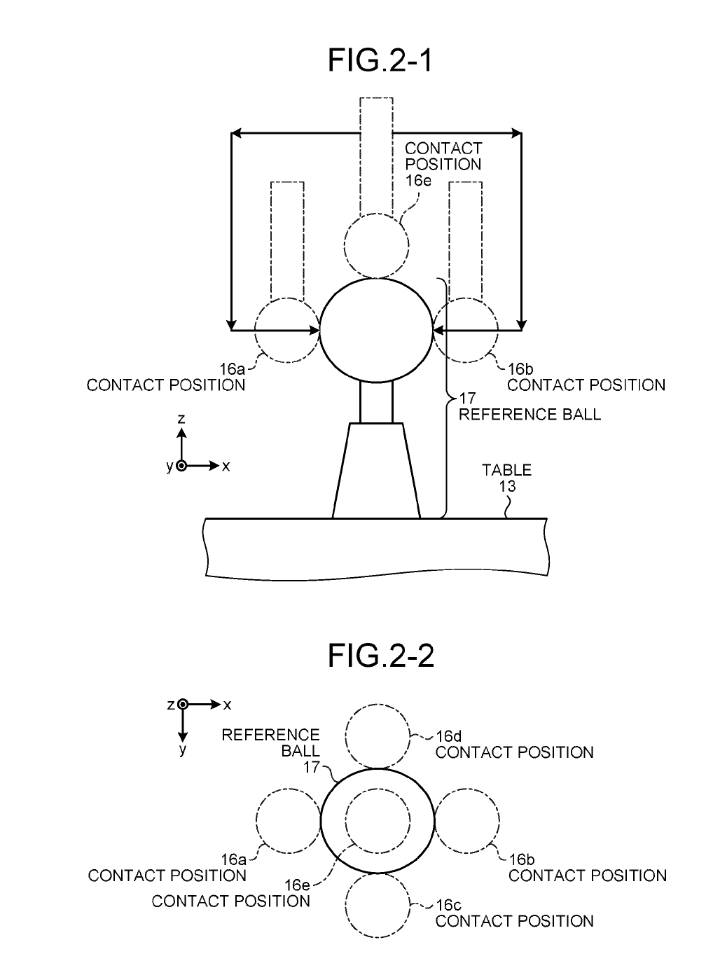

FIGS. 2-1 and 2-2 are explanatory diagrams of the positioning of the columnar center. At a time of positioning the columnar center, the electric discharge machine 100 drives the main spindle 15 to move the reference electrode 16 in the x-axis, y-axis, and z-axis directions, and measures contact positions at which the reference electrode 16 contacts the reference ball 17 in the x-axis, y-axis, and z-axis directions, respectively. The electric discharge machine 100 can measure the contact positions by applying a voltage between the reference electrode 16 and the reference ball 17 to move the reference electrode 16, and by recording the positions at times of detecting a current flowing between the reference electrode 16 and the reference ball 17. The electric discharge machine 100 calculates a central position of the reference ball 17 from the obtained contact positions. As shown in FIGS. 2-1 and 2-2, an intermediate position between a contact position 16a and a contact position 16b corresponds to an x-axis direction component of the central position of the reference ball 17. An intermediate position between contact positions 16c and 16d corresponds to a y-axis direction component of the central position of the reference ball 17. A value obtained by subtracting a radius of the reference ball 17 from a contact position 16e corresponds to a z-axis direction component of the central position of the reference ball 17. A displacement amount of the main spindle 15 corresponds to a difference between the calculated central position and set values of the machine coordinates of the central position.

During measurement of the temperature and the displacement amount, data different from an assumed environmental temperature (error data) is often obtained because of, for example, disturbance due to opening or closing of a door of a room where the electric discharge machine 100 is installed, a failure of an air-conditioner, or failures of the temperature sensors 18a to 18c. To prevent the displacement amount from being corrected using the correction coefficients calculated based on measurement data without being aware that the measurement data is the error data, the electric discharge machine 100 according to the first embodiment of the present invention displays at least either the transition of the measured temperature or the transition of the displacement amount of the position of the columnar center before applying the calculated correction coefficients, thereby making it possible for the user to confirm that the measurement data includes no error data.

Furthermore, the electric discharge machine 100 according to the first embodiment of the present invention displays graphs for a comparison of the correction effects between a case of applying the correction coefficients used so far and a case of applying newly calculated correction coefficients so as to be able to improve the correction effect, thereby making it possible for the user to select whether to change the set values of the correction coefficients.

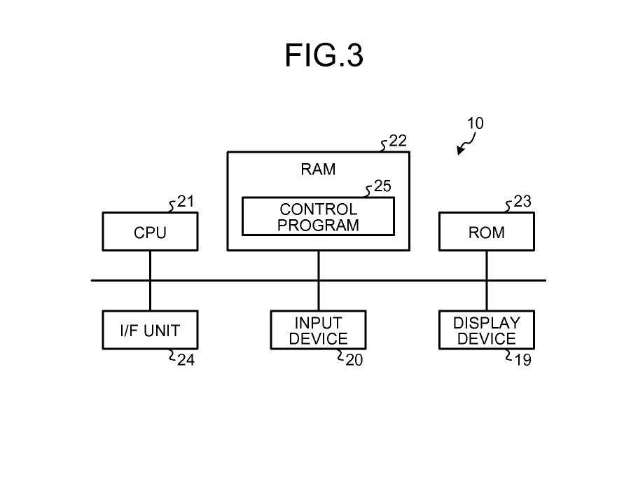

FIG. 3 is an explanatory diagram of an example of a hardware configuration of the control device 10. As shown in FIG. 3, the control device 10, which is configured similarly to an ordinary computer, includes a CPU (Central Processing Unit) 21, a RAM (Random Access Memory) 22, a ROM (Read Only Memory) 23, and an interface (I/F) unit 24 besides the display device 19 and the input device 20. The CPU 21, the RAM 22, the ROM 23, the I/F unit 24, the display device 19, and the input device 20 are connected to one another via a bus line.

The I/F unit 24 is an interface for connecting the control device 10 to the main-spindle drive unit 14 and the temperature sensors 18a to 18c, and the CPU 21 performs communication with these constituent elements via the I/F unit 24. The display device 19 displays output information for a user such as an operation screen based on commands from the CPU 21. Operation information on the operation of the control device 10 is input from the user to the input device 20. The operation information input to the input device 20 is transmitted to the CPU 21.

A control program 25 is stored in the ROM 23 and loaded into the RAM 22 via the bus line. The CPU 21 executes the control program 25 loaded into the RAM 22. Specifically, when a startup command is input to the input device 20 from the user, the CPU 21 reads the control program 25 from within the ROM 23 and loads the read control program 25 into a program storage region within the RAM 22. The control program 25 can be stored in a storage device such as a DISK. Furthermore, the control program 25 can be loaded into a storage device such as a DISK.

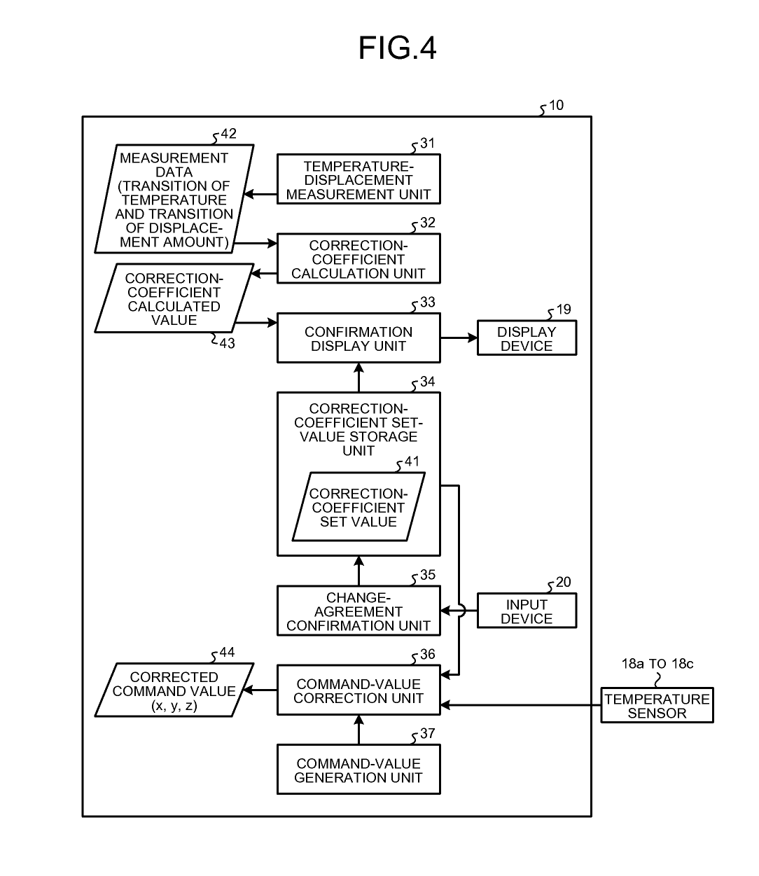

The CPU 21 operates as functional constituent elements described next based on the control program 25 loaded into the RAM 22. FIG. 4 is an explanatory diagram of a functional configuration of the control device 10.

As shown in FIG. 4, the control device 10 includes a temperature/displacement measurement unit (measurement unit) 31, a correction-coefficient calculation unit 32, a confirmation display unit 33, a correction-coefficient set-value storage unit (set-value storage unit) 34, a change-agreement confirmation unit (setting change unit) 35, a command-value correction unit 36, and a command-value generation unit 37.

The command-value generation unit 37 generates a command value for driving the main-spindle drive unit 14 based on a user program (not shown) set by the user in advance.

The correction-coefficient set-value storage unit 34 is a storage region in which the set values of the correction coefficients (correction-coefficient set values 41) are stored and is secured in, for example, the RAM 22.

The command-value correction unit 36 calculates the corrected amount using the temperature detected values detected by the temperature sensors 18a to 18c and the correction-coefficient set values 41 stored in the correction-coefficient set-value storage unit 34, corrects the command value generated by the command-value generation unit 37 by subtracting the calculated corrected amount from the command value, and outputs a corrected command value (a corrected command value 44) to the main-spindle drive unit 14. The command value generated by the command-value generation unit 37 is constituted by commands relating to the x-axis component, the y-axis component, and the z-axis component. The corrected command value is constituted by correcting the command values relating to the x-axis component, the y-axis component, and the z-axis component, respectively.

The temperature-displacement measurement unit 31 measures the transition of the temperature and the transition of the displacement amount. Specifically, the temperature-displacement measurement unit 31 measures the displacement amount by driving the main-spindle drive unit 14 to execute positioning of the columnar center and captures the detected values of the temperature sensors 18a to 18c. The temperature-displacement measurement unit 31 measures displacement amounts and temperatures at a predetermined time interval (a 1-hour interval, for example), and sequentially records obtained measurement results in each of which time is added, thereby obtaining the measurement result of the transition of temperature and the transition of the displacement amount. After finishing measuring the transition of temperature and the transition of the displacement amount, the temperature-displacement measurement unit 31 outputs the measurement result as measurement data 42.

The correction-coefficient calculation unit 32 calculates the correction coefficients based on the measurement data 42 and outputs the calculated correction coefficients as correction-coefficient calculated values 43. While a correction-coefficient calculation method adopted by the correction-coefficient calculation unit 32 is not limited to a specific method, an example of the method is described below.

It is assumed that temperatures and displacement amounts measured at a 1-hour interval for 24 hours are recorded in the measurement data 42. When it is defined that measured values of the temperature sensors 18a to 18c at a time tn (1≦n≦24, where n is an integer) are Tan, Tbn, and Tcn, respectively and that correction coefficients for calculating a corrected amount in the x-axis direction is KXa, KXb, KXc, and KXconst, a displacement amount Xn of the main spindle 15 in the x-axis direction at the time tn can be expressed as follows.

Xn=KXa*Tan+KXb*Tbn+KXc*Tcn+KXconst (1)

Because Equation (1) is set up for n=1 to 24, the correction-coefficient calculation unit 32 calculates the KXa, the KXb, the KXc, and the KXconst by setting up 24 simultaneous Equations (1). The correction-coefficient calculation unit 32 can calculate correction coefficients for the y-axis direction and the z-axis direction by the same method.

The confirmation display unit 33 displays the measurement result based on the measurement data 42, and displays a comparison between the correction effect by the correction-coefficient set values 41 stored in the correction-coefficient set-value storage unit 34 and that by the correction-coefficient calculated values 43 calculated by the correction-coefficient calculation unit 32. The confirmation display unit 33 also displays a screen prompting a user to input information as to whether to use the calculated correction-coefficient calculated values 43.

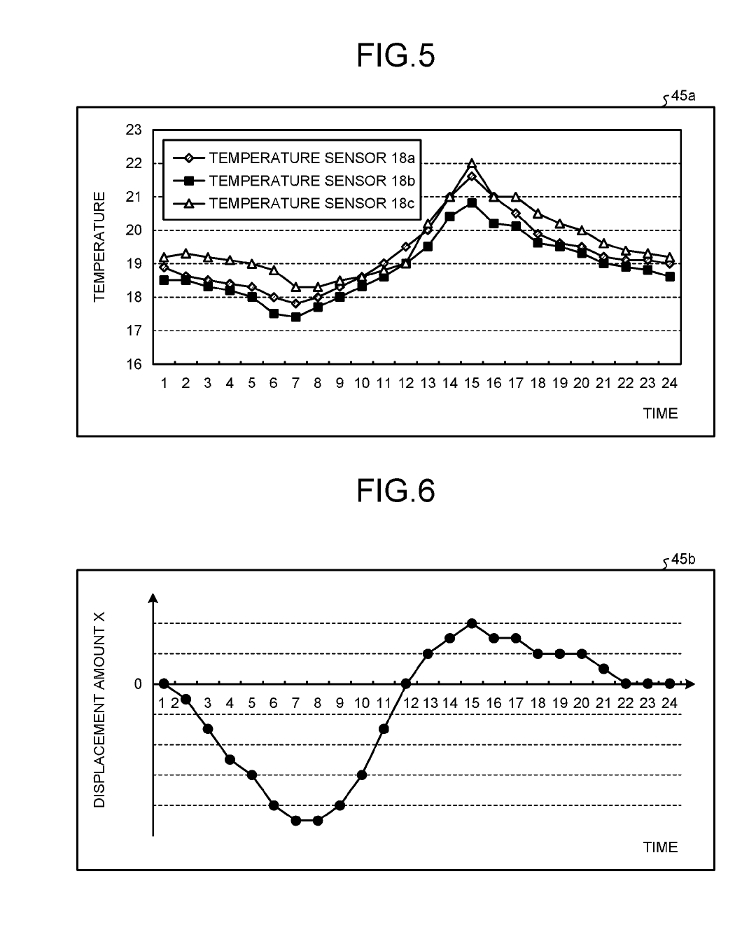

FIG. 5 is an explanatory diagram of an example of displaying temperature measurement results. According to this example, graphs of plotting measurement results measured at a 1-hour interval for 24 hours per temperature sensor are displayed on a display screen 45a. FIG. 6 is an explanatory diagram of an example of displaying displacement measurement results. According to this example, a graph of plotting the x-axis component of the displacement amount is displayed on a display screen 45b. A user can determine whether the measurement result is appropriate when viewing the display screens 45a and 45b. For example, when the user opens or closes the door of the room where the electric discharge machine 100 is installed at a certain time and either the temperature or the displacement amount greatly changes at that time, the user can determine that it is not appropriate to calculate the correction coefficients using the measurement result.

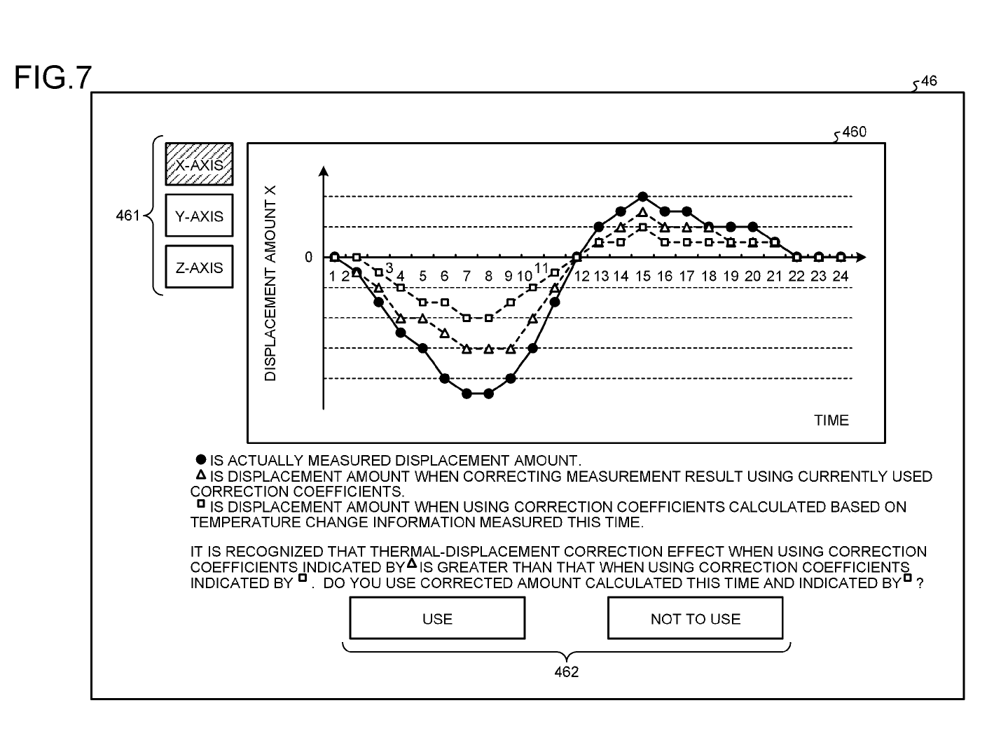

FIG. 7 is an explanatory diagram of an example of displaying a comparison between respective correction effects. In graphs shown in a region 460 on a display screen 46, points indicated by black circles show a measurement result of the displacement amount, points indicated by white triangles show a corrected displacement amount corrected using the correction-coefficient set values 41, and points indicated by white rectangles show a corrected displacement amount corrected using the correction-coefficient calculated values 43. According to this display screen 46, it is understood that the correction effect in a case of correcting the measurement result using the correction-coefficient calculated values 43 is greater than that in a case of correcting the measurement result using the correction-coefficient set values 41. The display screen 46 includes three touch panel buttons 461 for selecting the x-axis component, the y-axis component, and the z-axis component, respectively, and a user can select the component of the displacement amount to be displayed in the region 460 by an input via one of the touch panel buttons 461.

Furthermore, the display screen 46 includes touch panel buttons 462 for selecting whether to use the correction-coefficient calculated values 43, and the user can select whether or not to use the newly calculated correction-coefficient calculated values 43.

The confirmation display unit 33 can display both of or one of the temperature and the displacement amount in relation to the display of the measurement result. Furthermore, the confirmation display unit 33 can display the measurement result and the correction effects on the same screen or by switching the display of measurement result to or from that of the correction effects based on the user's input.

The change-agreement confirmation unit 35 updates the correction-coefficient set values 41 to the correction-coefficient calculated values 43 in response to the input to the effect of using the correction-coefficient calculated values 43 via one of the touch panel buttons 462.

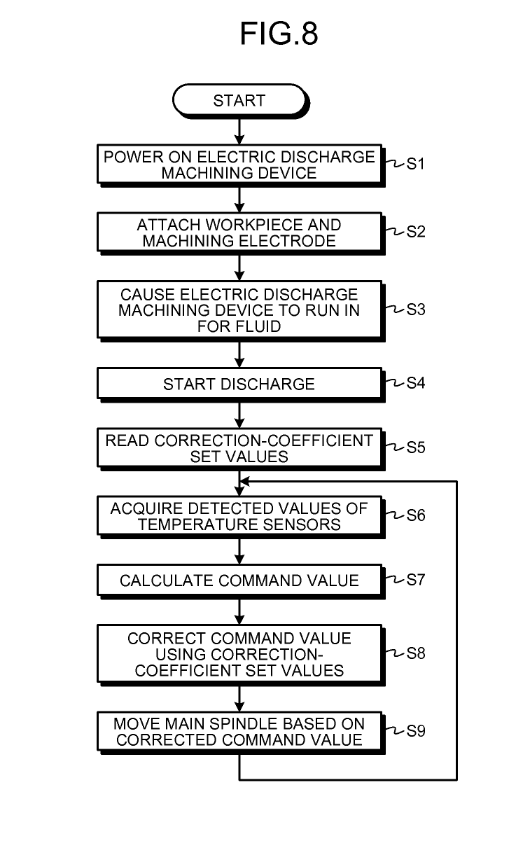

An operation performed by the electric discharge machine 100 according to the first embodiment is explained next with reference to FIGS. 8 to 10.

FIG. 8 is a flowchart for explaining an operation performed by the electric discharge machine 100 according to the first embodiment when electric discharge machining is performed. First, as shown in FIG. 8, after powering on the electric discharge machine 100 (Step S1), a user attaches the workpiece and the machining electrode (Step S2). Thereafter, the electric discharge machine 100 runs in for the working fluid for a while (Step S3) and starts the discharge (Step S4).

In the control device 10, the command-value correction unit 36 acquires the correction-coefficient set values 41 from the correction-coefficient set-value storage unit 34 (Step S5), and acquires the temperature detected values detected by the temperature sensors 18a to 18c (Step S6).

The command-value generation unit 37 calculates a command value (Step S7), and the command-value correction unit 36 corrects the command value calculated by the command-value generation unit 37 based on the acquired correction-coefficient set values 41 and the acquired temperature detected values detected by the temperature sensors 18a to 18c (Step S8). The main-spindle drive unit 14 moves a position of the main spindle 15 based on the corrected command value 44 output from the command-value generation unit 37 (Step S9).

The electric discharge machine 100 can move the position of the main spindle 15 to follow up the corrected command value 44 by repeatedly performing processes from Step S6 to Step S9.

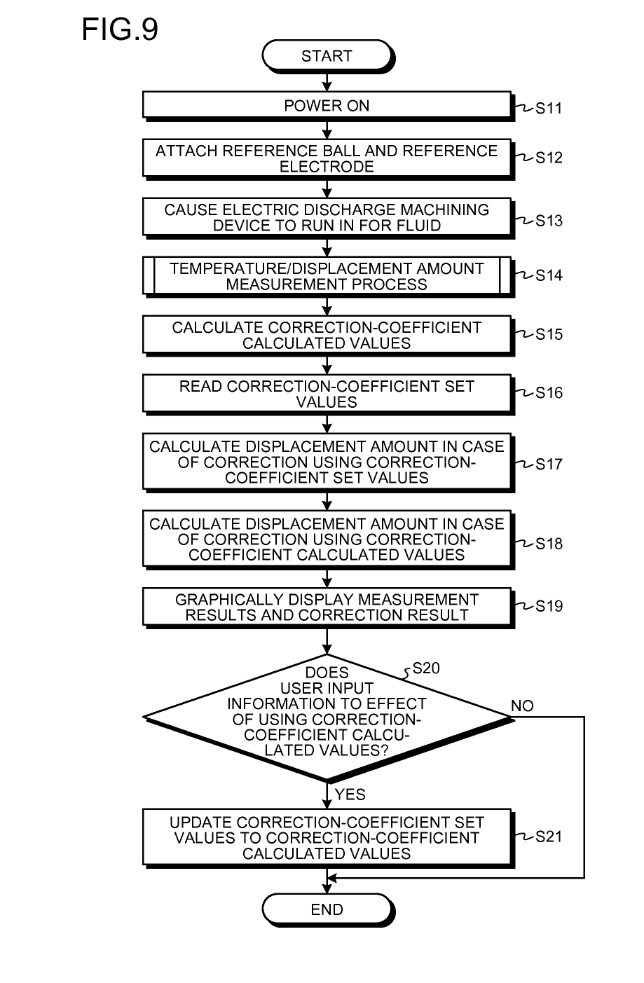

FIG. 9 is a flowchart for explaining an operation performed by the electric discharge machine 100 according to the first embodiment when correction coefficients are calculated. First, for the calculation of the correction coefficients, after powering on the electric discharge machine 100 (Step S11), a user attaches the reference ball 17 and the reference electrode 16 (Step S12). Thereafter, the electric discharge machine 100 runs in for the working fluid for a while (Step S13) and performs a temperature/displacement amount measurement process (Step S14).

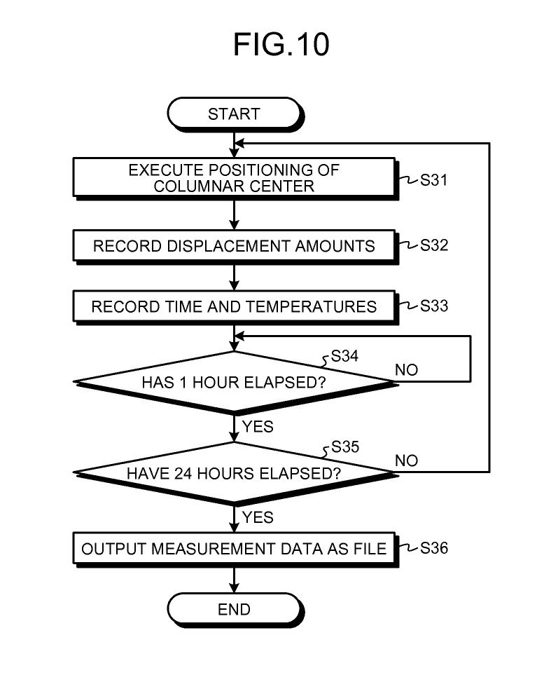

FIG. 10 is a flowchart for explaining the temperature/displacement amount measurement process at Step S14 in more detail. As shown in FIG. 10, when the temperature/displacement amount measurement process starts, the temperature-displacement measurement unit 31 executes the positioning of the columnar center (Step S31) and records the obtained displacement amounts in the measurement data 42 (Step S32). The temperature-displacement measurement unit 31 acquires the detected values of the temperature sensors 18a to 18c and the time, and records the acquired detected values and the time in the measurement data 42 while associating the time with the displacement amounts recorded at Step S32, respectively (Step S33).

The temperature-displacement measurement unit 31 determines whether 1 hour has elapsed after the process at Step S33 (Step S34), and performs again a determination process at Step S34 when 1 hour has not elapsed (NO at Step S34). When 1 hour has elapsed after the process of Step S33 (YES at Step S34), the temperature-displacement measurement unit 31 further determines whether or not 24 hours have elapsed after the process at Step S33 (Step S35). When 24 hours have not elapsed (NO at Step S35), the temperature-displacement measurement unit 31 performs a process at Step S31. When 24 hours have elapsed (YES at Step S35), the temperature-displacement measurement unit 31 outputs the measurement data 42 as a file (Step S36) and completes the temperature/displacement amount measurement process.

Referring back to FIG. 9, after the temperature/displacement amount measurement process at Step S14, the correction-coefficient calculation unit 32 calculates the correction-coefficient calculated values 43 based on the measurement data 42 output from the temperature-displacement measurement unit 31 (Step S15).

The confirmation display unit 33 reads the correction-coefficient set values 41 from the correction-coefficient set-value storage unit 34 (Step S16), and calculates the displacement amount in a case of correction using the read correction-coefficient set values 41 (Step S17). Furthermore, the confirmation display unit 33 calculates the displacement amount in the case of correcting the measurement result using the correction-coefficient calculated values 43 calculated by a process performed by the correction-coefficient calculation unit 32 at Step S15 (Step S18). The confirmation display unit 33 processes the measurement data 42 and the corrected displacement amounts in cases of correction using the respective correction-coefficients for display, and graphically displays the processed measurement data 42 and the processed displacement amounts on the display device 19 (Step S19).

A user can confirm contents graphically displayed on the display device 19 and input the information as to whether to use the correction-coefficient calculated values 43 to the input device 20. The change-agreement confirmation unit 35 determines whether or not the user inputs the information to the effect of using the correction-coefficient calculated values 43 (Step S20). When the user inputs the information to the effect of using the correction-coefficient calculated values 43 (YES at Step S20), the change-agreement confirmation unit 35 updates the correction-coefficient set values 41 stored in the correction-coefficient set-value storage unit 34 to the correction-coefficient calculated values 43 by overwriting the correction-coefficient calculated values 43 on the correction-coefficient set values 41 (Step S21), whereby the operation performed by the electric discharge machine 100 for the calculation of the correction coefficients ends. When the user does not input the information to the effect of using the correction-coefficient calculated values 43 (NO at Step S20), a process at Step S21 is skipped.

In this way, according to the first embodiment of the present invention, the electric discharge machine 100 is configured to include the temperature-displacement measurement unit 31 that measures the transition of the displacement of the reference position and the transition of the detected values of the temperature sensors 18a to 18c, the correction-coefficient calculation unit 32 that calculates the correction-coefficient calculated values 43 based on the measurement result of the temperature-displacement measurement unit 31, the confirmation display unit 33 that displays the measurement result of the temperature-displacement measurement unit 31 and that prompts the user to input the information as to whether or not to use the correction-coefficient calculated values 43, and the change-agreement confirmation unit 35 that updates the correction-coefficient set values 41 stored in the correction-coefficient set-value storage unit 34 to the correction-coefficient calculated values 43 when the input to the effect of using the correction-coefficient calculated values 43 is received. Therefore, the correction-coefficient set values 41 can be corrected based on the environmental temperature of the installation environment. Furthermore, because the user can select whether or not to update the correction-coefficient set values 41 after confirming the measurement data, it is possible to prevent the correction-coefficient set values 41 from being updated to the correction-coefficient calculated values 43 calculated based on the error data. That is, it is possible to make corrections as effectively as possible according to the environmental temperature of the installation location.

Furthermore, the electric discharge machine 100 is configured so that the confirmation display unit 33 further displays a comparison of the correction effects between the correction-coefficient set values 41 stored in the correction-coefficient set-value storage unit 34 and the correction-coefficient calculated values 43 when prompting a user to input the information as to whether to use the correction-coefficient calculated values 43. Therefore, the user can update the correction-coefficient set values 41 after confirming improvement in the correction effect. Therefore, it is possible to further ensure setting the correction-coefficient set values 41 having a greater correction effect.

The electric discharge machine 100 can be configured so that the control program 25 executed by the control device 10 according to the present first embodiment is stored on a computer connected to a network such as the Internet and provided by being downloaded via the network. Alternatively, the electric discharge machine 100 can be configured so that the control program 25 executed by the control device 10 according to the present first embodiment is provided or distributed via a network such as the Internet. Alternatively, the control program 25 according to the present first embodiment can be incorporated in advance in a ROM or the like and provided to the control device 10 according to the first embodiment.

### Second Embodiment

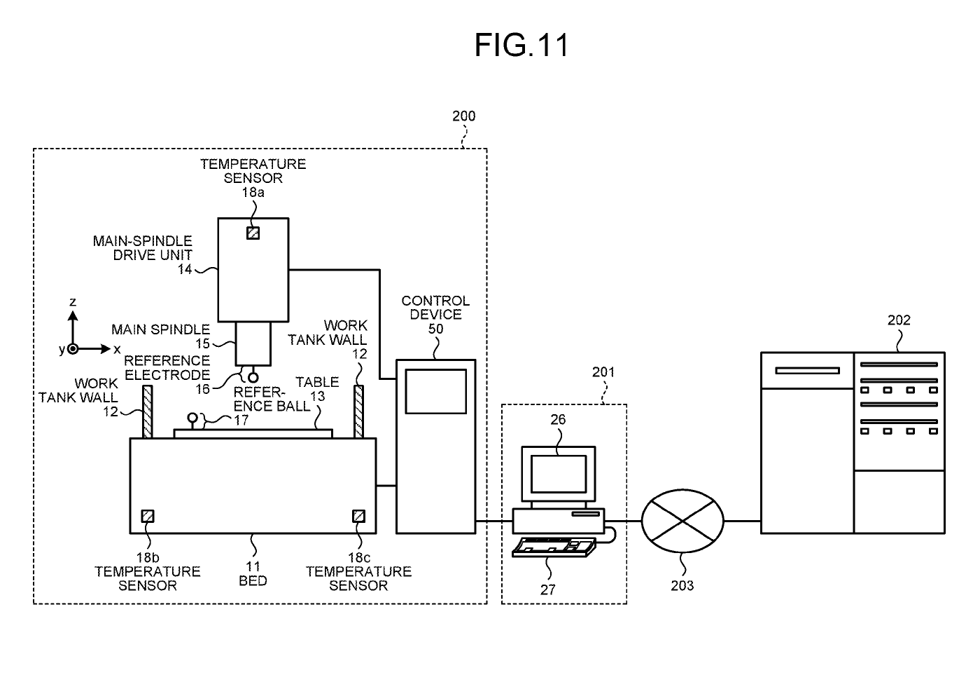

FIG. 11 is an explanatory diagram of a configuration of an electric discharge machining system according to a second embodiment of the present invention. As shown in FIG. 11, the electric discharge machining system according to the second embodiment includes an electric discharge machine 200, a computer terminal 201, and a server 202. The electric discharge machine 200 is connected to the computer terminal 201 by, for example, a serial communication line or the Ethernet (Registered Trademarks). On the other hand, the server 202 is prepared by a manufacturer and the computer terminal 201 is connected to the server 202 via the Internet 203. In the following explanations, constituent elements identical to those of the first embodiment are denoted by like reference signs and redundant explanations thereof will be omitted.

The electric discharge machine 200 includes the bed 11, the work tank walls 12, the table 13, the main-spindle drive unit 14, the main spindle 15, the temperature sensors 18a to 18c, and a control device 50. The reference electrode 16 is attached to the main spindle 15 and the reference ball 17 is installed on the table 13. Because a hardware configuration of the control device 50 is identical to that of the first embodiment, explanations thereof will be omitted.

The computer terminal 201 is configured similarly to an ordinary personal computer, which includes an arithmetic unit such as a CPU, a storage device constituted by a hard disk, a ROM, a RAM, and the like, an input device 27 constituted by a keyboard or a pointing device, and a display device 26 constituted by a CRT, an LCD or the like.

The server 202 is similar in a hardware configuration to an ordinary server computer including a storage device constituted by an arithmetic unit such as a CPU and a storage device constituted by a hard disk, a ROM, a RAM, and the like. It is assumed here that the server 202 functions as a web server that makes open an Internet site (a support site) for supporting a user who uses the electric discharge machine 200, and that receives provision of information on the computer terminal 201 and input from the computer terminal 201 according to the HTTP (Hypertext Transfer Protocol).

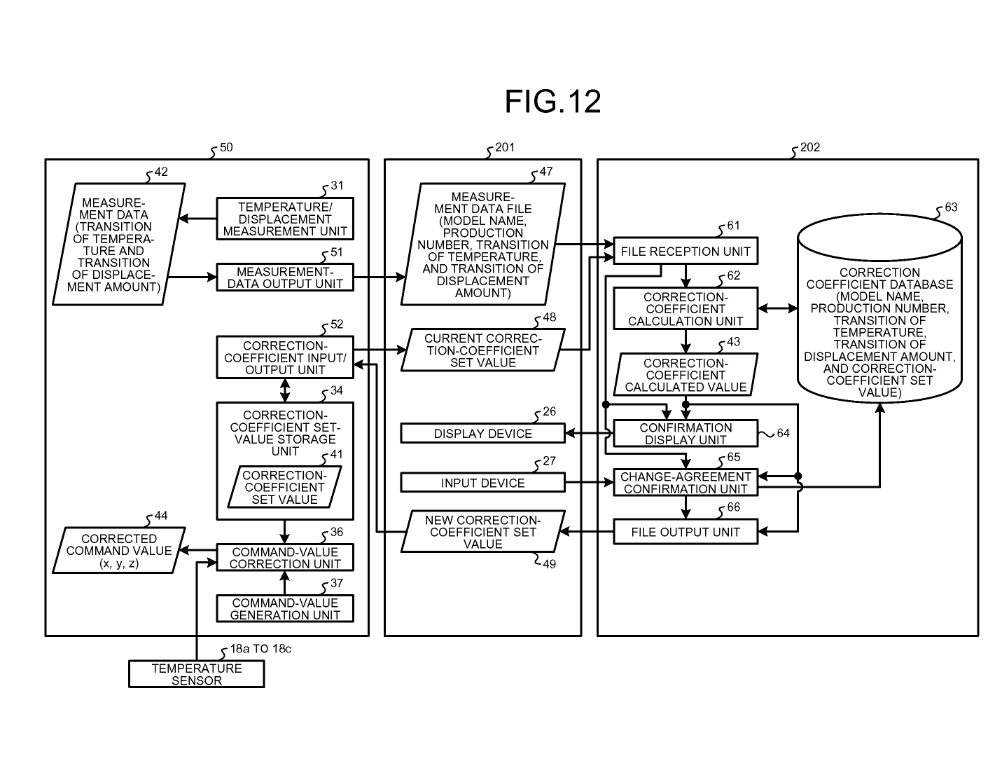

FIG. 12 is an explanatory diagram of functional configurations of the control device 50 and the server 202 according to the second embodiment.

As shown in FIG. 12, the control device 50 includes the temperature-displacement measurement unit 31 that outputs the measurement data 42, a measurement-data output unit 51, a correction-coefficient input/output unit 52, the correction-coefficient set-value storage unit 34 that holds the correction-coefficient set values 41, the command-value generation unit 37, and the command-value correction unit 36 that corrects a command value output from the command-value generation unit 37 based on the detected values of the temperature sensors 18a to 18c and that outputs the corrected command value 44 to the main-spindle drive unit 14.

The measurement-data output unit 51 adds a model name and a production number of the electric discharge machine 200 to the measurement data 42 output from the temperature-displacement measurement unit 31 and outputs the measurement data 42 as a measurement data file 47. The measurement data file 47 output from the measurement-data output unit 51 is input to the computer terminal 201 and is input to the server 202 via the Internet 203.

The correction-coefficient input/output unit 52 reads the correction-coefficient set values 41 stored in the correction-coefficient set-value storage unit 34 and outputs the read correction-coefficient set values 41 as current correction-coefficient set values 48. The current correction-coefficient set values 48 are input to the server 202 similarly to the measurement data file 47. Furthermore, when new correction-coefficient set values 49 that are correction coefficients calculated by the server 202 are input to the electric discharge machine 200, the correction-coefficient input/output unit 52 captures the input new correction-coefficient set values 49 and updates the correction-coefficient set values 41 stored in the correction-coefficient set-value storage unit 34 to the correction-coefficient set values 49 by overwriting the correction-coefficient set values 49 on the correction-coefficient set values 41.

The server 202 includes a file reception unit (data reception unit) 61, a correction-coefficient calculation unit 62, a correction coefficient database (database unit) 63, a confirmation display unit 64, a change-agreement confirmation unit 65, and a file output unit 66.

The file reception unit 61 receives the measurement data file 47 and the current correction-coefficient set values 48 input from the computer terminal 201 via the Internet 203.

The correction coefficient database 63 is a database that accumulates and stores therein the model name and the production number of the electric discharge machine 200, the measured transition of the temperature and the measured transition of the displacement amount, and the correction-coefficient set values set for the transition of the temperature and the transition of the displacement amount while associating these elements with one another.

According to the second embodiment, the model name and the production number are included as a data configuration of the correction coefficient database 63. Therefore, measurement data and correction-coefficient set values related to a plurality of models of the electric discharge machines 200 can be registered in the correction coefficient database 63 despite whether the models are manufactured by the same manufacturer. Because the manufacturer can acquire histories of the user's environmental temperature and conditions of the electric discharge machine 200 by referring to various data accumulated in the correction coefficient database 63, the correction coefficient database 63 can be used for improvement in the quality of user support.

The correction-coefficient calculation unit 62 calculates the correction-coefficient calculated values 43 based on the transition of the temperature and the transition of the displacement amount recorded in the measurement data file 47. Furthermore, the correction-coefficient calculation unit 62 refers to the correction coefficient database 63 and determines whether to output the correction-coefficient set values calculated based on the measurement data file 47 input to the file reception unit 61. It is assumed here that the correction-coefficient calculation unit 62 determines whether the measurement data file 47 received by the file reception unit 61 is error data, does not output the correction-coefficient set values when determining that the measurement data file 47 is the error data, and outputs the correction-coefficient set values when determining that the measurement data file 47 is not the error data. Furthermore, when determining that the measurement data file 47 is not the error data, the correction-coefficient calculation unit 62 creates a new entry in the correction coefficient database 63 and registers contents of the measurement data file 47 in the entry. While any method can be used as a method of determining whether the measurement data file 47 is the error data, a determination method by a statistic method using the correction-coefficient set values registered in the measurement data file 47 as a population is explained as an example.

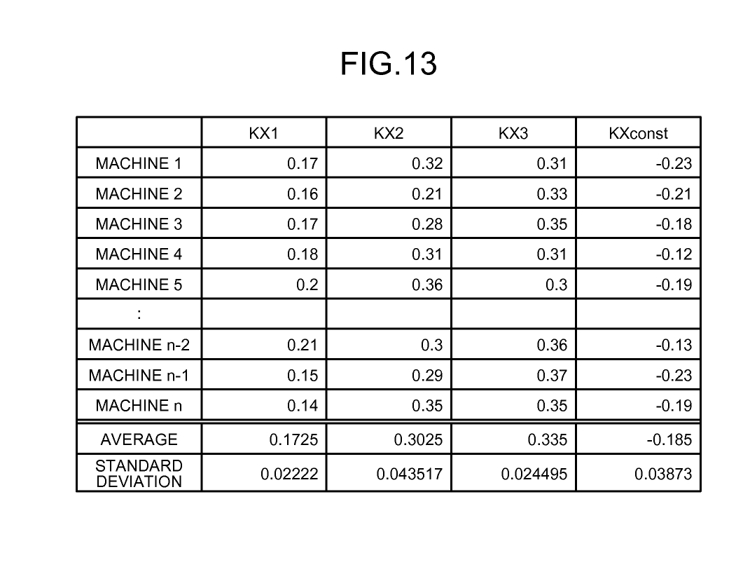

The correction-coefficient calculation unit 62 searches the correction coefficient database 63 using the model name recorded in the measurement data file 47 as a search key, and extracts the correction-coefficient set values for the same model. FIG. 13 is a list of the extracted correction-coefficient set values. As shown in FIG. 13, the correction-coefficient set values (KX1, KX2, KX3, and KXconst) are listed up in order of the production number.

Subsequently, the correction-coefficient calculation unit 62 calculates an average value μ and a standard deviation σ of the correction-coefficient set values for the same model using the extracted correction-coefficient set values (KX1, KX2, KX3, and KXconst) as the population. The correction-coefficient calculation unit 62 confirms whether the newly calculated correction-coefficient calculated values 43 fall within a range from μ−2*σ to μ+2*σ. When a distribution of the correction-coefficient set values is to follow a normal distribution, a probability that the correction-coefficient calculated values 43 fall within the above range exceeds 95%. Therefore, if the correction-coefficient calculated values 43 do not fall within this range, the correction-coefficient calculation unit 62 determines that the measurement data file 47 based on which the correction-coefficient calculated values 43 are calculated is the error data. The correction-coefficient calculation unit 62 can calculate the average value μ and the standard deviation σ for each of the extracted KX1, KX2, KX3, and KXconst, and can determine that the measurement data file 47 is the error data when any one of the KX1, KX2, KX3, and KXconst constituting the correction-coefficient calculated values 43 is out of the range from μ−2*σ to μ+2*σ.

The correction-coefficient calculation unit 62 can determine whether the measurement data file 47 is the error data using the temperatures and the displacement amounts registered in the measurement data file 47 as a population.

The confirmation display unit 64 displays, as a comparison, a correction effect by the current correction-coefficient set values 48 received by the file reception unit 61 and that by the correction-coefficient calculated values 43 calculated by the correction-coefficient calculation unit 62 on the display device 26 of the computer terminal 201.

The change-agreement confirmation unit 65 registers the correction-coefficient calculated values 43 in the entry, which is created in the correction coefficient database 63 by the correction-coefficient calculation unit 62 and in which the contents of the measurement data file 47 are registered, when information to the effect of using the correction-coefficient calculated values 43 is input from the computer terminal 201. The change-agreement confirmation unit 65 registers the current correction-coefficient set values 48 in the entry when information to the effect of not using the correction-coefficient calculated values 43 (that is, to the effect of using the correction-coefficient set values 41 currently stored in the correction-coefficient set-value storage unit 34) is input from the computer terminal 201.

The file output unit 66 outputs the correction-coefficient calculated values 43 to the computer terminal 201 as the new correction-coefficient set values 49 when the information to the effect of using the correction-coefficient calculated values 43 is input.

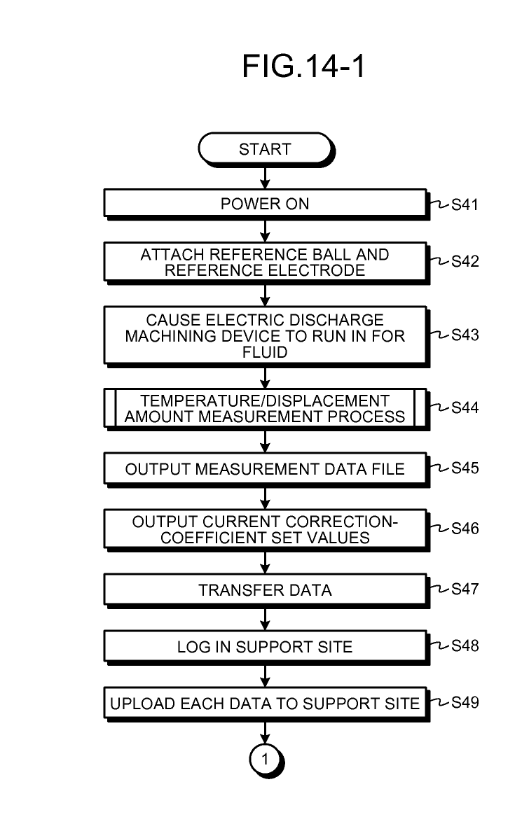

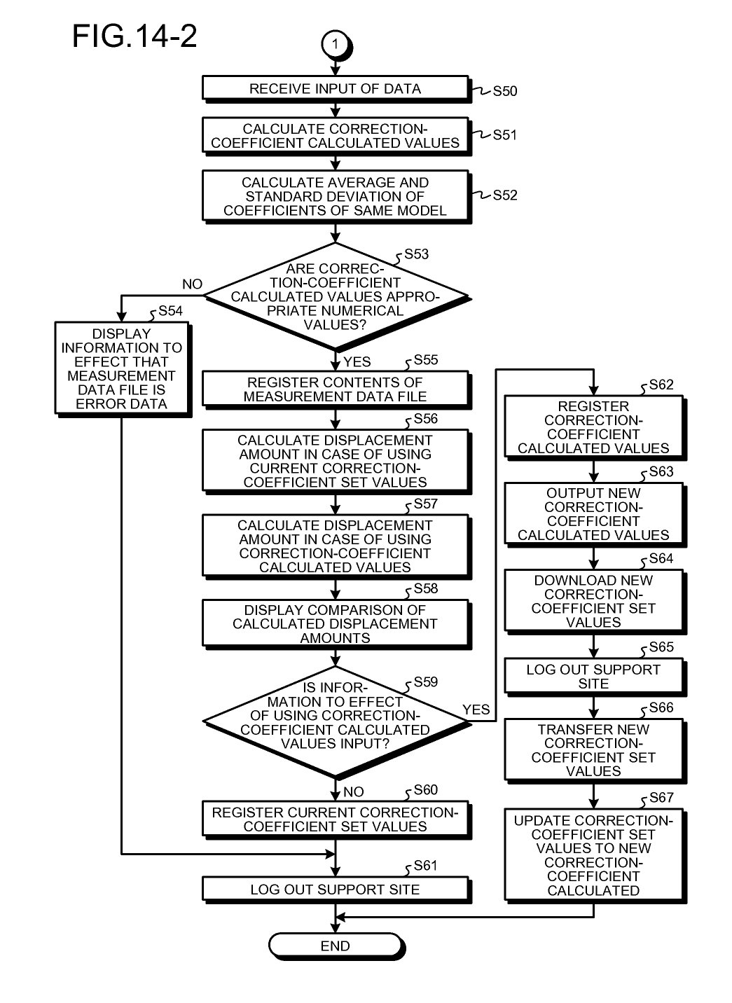

FIGS. 14-1 and 14-2 are flowcharts for explaining an operation performed by the electric discharge machining system according to the second embodiment when correction coefficients are calculated. First, for the calculation of the correction coefficients, after powering on the electric discharge machine 200 (Step S41), a user attaches the reference ball 17 and the reference electrode 16 (Step S42). Thereafter, the electric discharge machine 200 runs in for the working fluid for a while (Step S43) and performs the temperature/displacement amount measurement process (Step S44). Details of the temperature/displacement amount measurement process are identical to those of the process having the same name according to the first embodiment.

After the temperature/displacement amount measurement process, the measurement-data output unit 51 outputs the measurement data file 47 (Step S45). Furthermore, the correction-coefficient input/output unit 52 reads the correction-coefficient set values 41 stored in the correction-coefficient set-value storage unit 34 and outputs the read correction-coefficient set values 41 as the current correction-coefficient set values 48 (Step S46).

The user transfers the output measurement data file 47 and the output current correction-coefficient set values 48 to the computer terminal 201 (Step S47). The user launches a browser program on the computer terminal 201 and logs in the support site (Step S48), and uploads the measurement data file 47 and the current correction-coefficient set values 48 via the support site (Step S49).

In the server 202, the file reception unit 61 receives the uploaded measurement data file 47 and the uploaded current correction-coefficient set values 48 (Step S50). The correction-coefficient calculation unit 62 calculates the correction coefficients based on description contents of the received measurement data file 47 (Step S51). The correction coefficients are output as the correction-coefficient calculated values 43.

The correction-coefficient calculation unit 62 calculates the average value μ and the standard deviation σ of the correction-coefficient set values of the same model (Step S52), and determines whether the correction-coefficient calculated values 43 are appropriate values based on the calculated average value μ and the calculated standard deviation σ (Step S53). When determining that the correction-coefficient calculated values 43 are not the appropriate values (NO at Step S53), the correction-coefficient calculation unit 62 displays information to the effect that the measurement data file 47 is the error data on the computer terminal 201 (Step S54). The user shifts the operation to Step S61, at which the user logs out the support site, whereby the operation ends. When determining that the correction-coefficient calculated values 43 are the appropriate values (YES at Step S53), the correction-coefficient calculation unit 62 creates a new entry in the correction coefficient database 63 and registers the contents of the measurement data file 47 in the entry (Step S55).

Next, the confirmation display unit 64 calculates a displacement amount in a case of correction using the current correction-coefficient set values 48 received by the file reception unit 61 (Step S56). Furthermore, the confirmation display unit 64 calculates a displacement amount in a case of correction using the correction-coefficient calculated values 43 calculated by the correction-coefficient calculation unit 62 by a process at Step S51 (Step S57). The confirmation display unit 64 processes the corrected displacement amounts in the cases of corrections using the current correction-coefficient set values 48 and using the correction-coefficient calculated values 43, respectively, for display, and graphically displays the processed displacement amounts on the display device 26 that the computer terminal 201 includes (Step S58).

The user can confirm contents graphically displayed on the display device 26 and input the information as to whether to use the correction-coefficient calculated values 43 to the input device 27 that the computer terminal 201 includes. The change-agreement confirmation unit 65 determines whether the information to the effect of using the correction-coefficient calculated values 43 is input (Step S59). When the information to the effect of using the correction-coefficient calculated values 43 is not input (NO at Step S59), the change-agreement confirmation unit 65 registers the current correction-coefficient calculated values 48 in the correction coefficient database 63 (Step S60). Thereafter, the user logs out the support site (Step S61), and the operation ends.

When the information to the effect of using the correction-coefficient calculated values 43 is input (YES at Step S59), the change-agreement confirmation unit 65 registers the correction-coefficient calculated values 43 in the correction coefficient database 63 (Step S62), and the file output unit 66 outputs the correction-coefficient calculated values 43 as the new correction-coefficient set values 49 (Step S63). Thereafter, the user downloads the new correction-coefficient set values 49 to the computer terminal 201 (Step S64) and logs out the support site (Step S65). The user transfers the downloaded new correction-coefficient set values 49 to the control device 50 of the electric discharge machine 200 (Step S66).

The correction-coefficient input/output unit 52 receives the transferred new correction-coefficient set values 49, updates the correction-coefficient set values 41 stored in the correction-coefficient set-value storage unit 34 to the new correction-coefficient set values 49 by overwriting the new correction-coefficient set values 49 on the correction-coefficient set values 41 (Step S67), and the operation ends.

In this way, according to the second embodiment of the present invention, the server 202 is configured to include the file reception unit 61 receiving the measurement data file 47 output from the electric discharge machine 200, and calculate and outputs the correction-coefficient calculated values 43 based on the measurement result recorded in the received measurement data file 47, and the server 202 further includes the correction coefficient database 63 accumulating and storing therein the measurement result or the correction-coefficient calculated values 43, and determines, when the new measurement data file 47 is input, whether to output the correction-coefficient set values based on the newly input measurement data file 47 based on the storage contents of the correction coefficient database 63. Therefore, it is possible to correct the correction-coefficient set values 41 based on the environmental temperature of the installation environment and to automatically decrease the probability that the measurement data used to calculate the correction-coefficient calculated values 43 is the error data. Therefore, it is possible to make corrections as effectively as possible according to the environmental temperature of the installation location.

Furthermore, the file reception unit 61 is configured to receive the input of the measurement data file 47 and the correction-coefficient set values (the current correction-coefficient set values 48) stored in the correction-coefficient set-value storage unit 34, and the server 202 further includes the confirmation display unit 64 that, when the new measurement data file 47 and the current correction-coefficient set values 48 are input, displays a comparison of the correction effects between the input current correction-coefficient set values 48 and the correction-coefficient calculated values 43 based on the measurement data file 47 and prompts a user to input whether to use the correction-coefficient calculated values 43, and the server 202 determines whether to output the correction-coefficient calculated values 43 based on the contents of the correction coefficient database 63 and on the input as to whether to use the correction-coefficient calculated values 43. Therefore, the user can update the correction-coefficient set values after confirming improvement in the correction effect. Therefore, it is possible to further ensure setting the correction-coefficient set values having a greater correction effect.

Further, the server 202 is configured to determine whether the newly calculated correction-coefficient calculated values 43 are appropriate values based on the statistic analysis using, as the population, the correction-coefficient set values accumulated and stored in the correction coefficient database 63. Therefore, it is possible to prevent the correction-coefficient calculated values 43 calculated based on the error data from being used when the measurement result recorded in the measurement data file 47 is the error data.

### Third Embodiment

According to the second embodiment, the temperatures, the displacement amounts, and the correction-coefficient set values for many models are accumulated in the server. An electric discharge machining system according to a third embodiment is configured to use the information accumulated in the server. The user can obtain appropriate correction-coefficient set values only by transmitting temperature-related measurement data.

The electric discharge machining system according to the third embodiment includes an electric discharge machine, a computer terminal, and a server similarly to the electric discharge machining system according to the second embodiment. The constituent elements of the electric discharge machining system according to the third embodiment are distinguished from those of the electric discharge machining system according to the second embodiment by denoting reference sign 300 to an electric discharge machine included in the electric discharge machining system according to the third embodiment, denoting reference sign 70 to a control device included in the electric discharge machining system according to the third embodiment, and denoting reference sign 302 to a server. Connection relations between the electric discharge machine 300 and the computer terminal 201 and between the computer terminal 201 and the server 302 are identical to those according to the second embodiment.

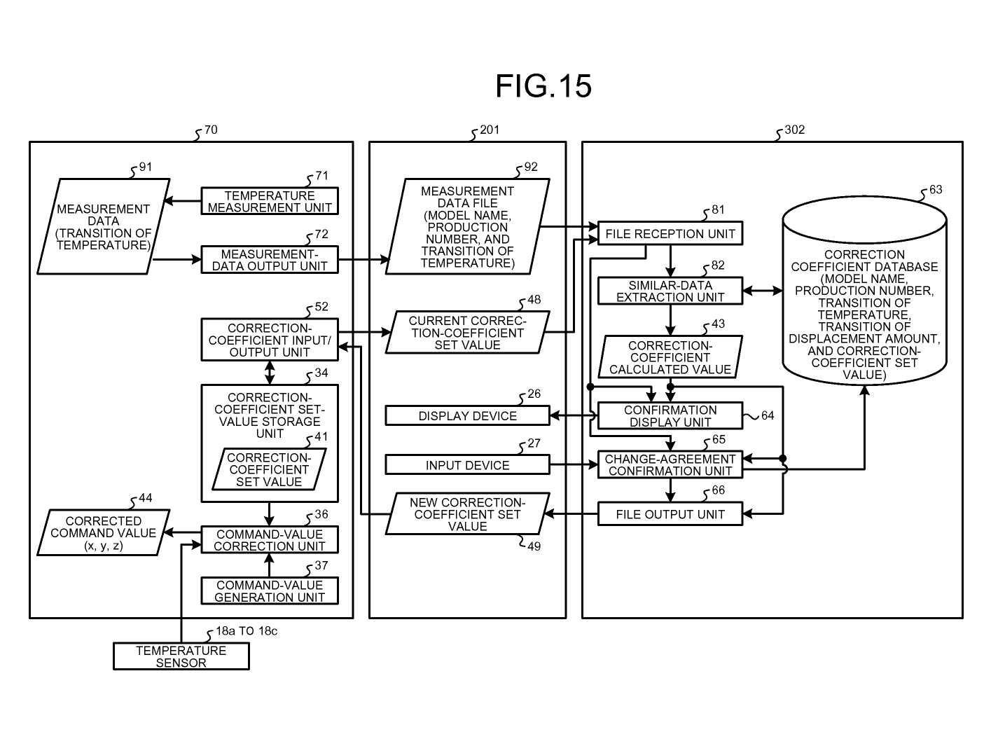

FIG. 15 is an explanatory diagram of functional configurations of the control device 70 and the server 302 according to the third embodiment.

As shown in FIG. 15, the control device 70 includes a temperature measurement unit 71, a measurement-data output unit 72, the correction-coefficient input/output unit 52, the correction-coefficient set-value storage unit 34 that holds the correction-coefficient set values 41, the command-value generation unit 37, and the command-value correction unit 36 that corrects a command value generated by the command-value generation unit 37 based on the detected values of the temperature sensors 18a to 18c and that outputs the corrected command value 44 to the main-spindle drive unit 14.

The temperature measurement unit 71 measures the transition of the temperature by acquiring the detected values of the temperature sensors 18a to 18c at a predetermined time interval, and outputs the measurement result as measurement data 91. The measurement-data output unit 72 adds a model name and a production name to the measurement data 91 output from the temperature measurement unit 71 and outputs the measurement data 91 to which the model name and the production name are added as a measurement data file 92.

The server 302 includes a file reception unit 81, a similar-data extraction unit 82, the correction coefficient database 63, the confirmation display unit 64, the change-agreement confirmation unit 65, and the file output unit 66.

The file reception unit 81 receives the measurement data file 92 and the current correction-coefficient set values 48 input from the computer terminal 201 via the Internet 203.

The similar-data extraction unit 82 searches the correction coefficient database 63 using the transition of the temperature described in the measurement data file 92 received by the file reception unit 81 as a search key, extracts the correction-coefficient set values associated with a transition of the temperature identical or similar to the described transition of the temperature, and outputs the extracted correction-coefficient set values as the correction-coefficient calculated values 43.

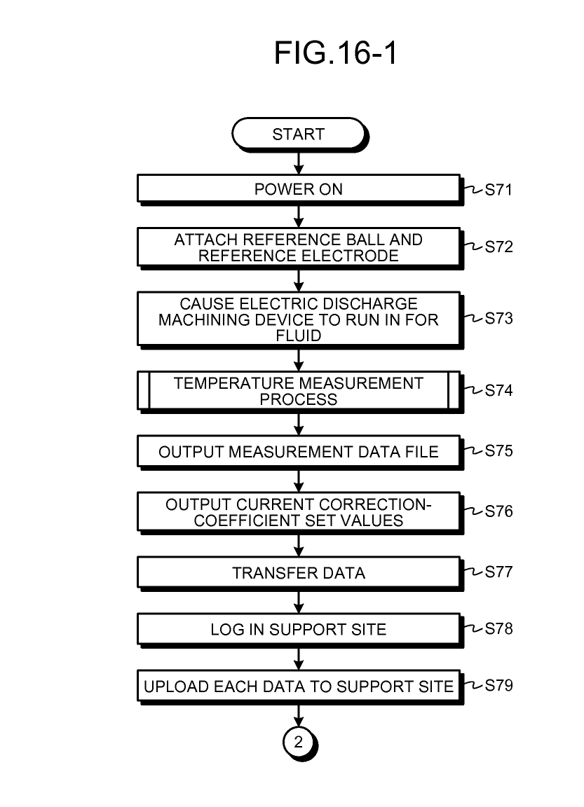

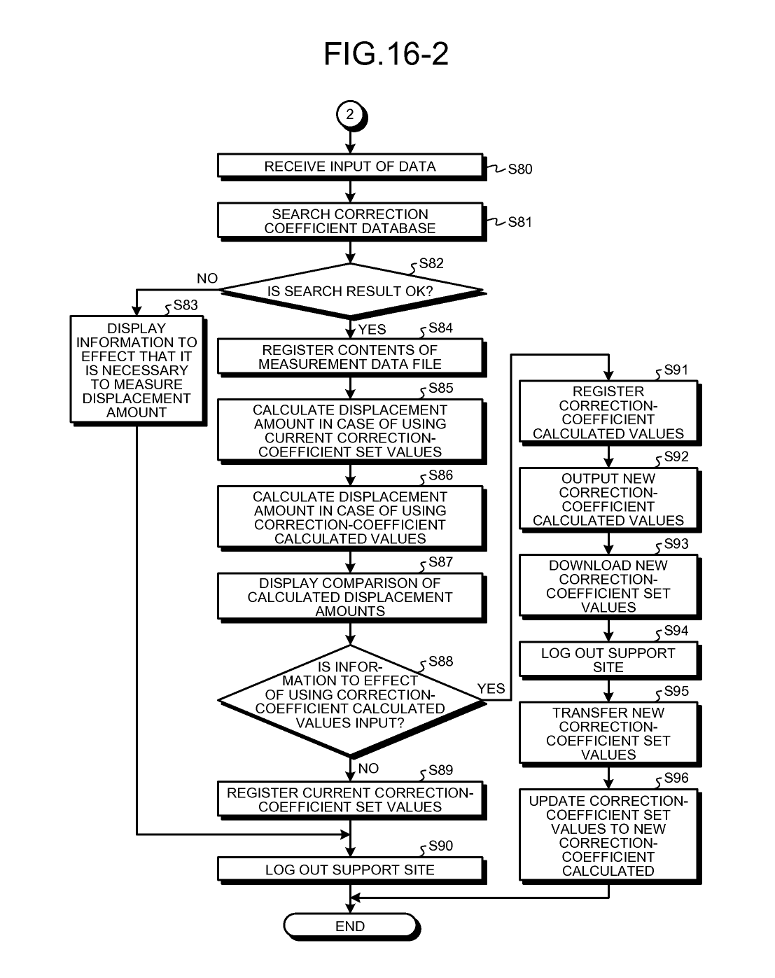

FIGS. 16-1 and 16-2 are flowcharts for explaining an operation performed by the electric discharge machining system according to the third embodiment when correction coefficients are performed. For the calculation of the correction coefficients, the electric discharge machining system performs processes at Steps S71 to S73 similar to those at Steps S41 to S43. Thereafter, the temperature measurement unit 71 performs a temperature measurement process for measuring the transition of the temperature and outputs the measurement data 91 (Step S74). Because the temperature measurement process is equivalent to the temperature/displacement amount measurement process in the first embodiment except for the measurement of the displacement amount, explanations of the process will be omitted.

After the temperature measurement process, the measurement-data output unit 72 outputs the measurement data file 92 (Step S75). Furthermore, the correction-coefficient input/output unit 52 reads the correction-coefficient set values 41 stored in the correction-coefficient set-value storage unit 34 and outputs the read correction-coefficient set values 41 as the current correction-coefficient set values 48 (Step S76).

A user transfers the output measurement data file 92 and the output current correction-coefficient set values 48 to the computer terminal 201 (Step S77). The user launches the browser program on the computer terminal 201 and logs in the support site (Step S78), and uploads the measurement data file 92 and the current correction-coefficient set values 48 via the support site (Step S79).

In the server 302, the file reception unit 81 receives the input of the measurement data file 92 and the current correction-coefficient set values 48 (Step S80). The similar-data extraction unit 82 searches the correction coefficient database 63 and tries to extract the correction-coefficient set values set for the transition of the temperature identical or similar to the transition of the temperature recorded in the measurement data file 92 (Step S81). When the search has no hits (NO at Step S82), the similar-data extraction unit 82 displays an indication to the effect that it is necessary to measure the displacement amount on the display device 26 of the computer terminal 201 (Step S83). After Step S83, the user logs out the support site (Step S90), and the operation ends.

When the correction-coefficient set values can be extracted by the search (YES at Step S82), the similar-data extraction unit 82 creates a new entry in the correction coefficient database 63 and registers contents of the measurement data file 92 in the entry (Step S84). The extracted correction-coefficient set values are output as the correction-coefficient calculated values 43.

Next, the confirmation display unit 64 calculates a displacement amount in a case of correction using the current correction-coefficient set values 48 received by the file reception unit 81 (Step S85). Furthermore, the confirmation display unit 64 calculates a displacement amount in a case of correction using the correction-coefficient calculated values 43 output from the similar-data extraction unit 82 (Step S86). The confirmation display unit 64 processes the corrected displacement amounts in the cases of corrections using the current correction-coefficient set values 48 and using the correction-coefficient calculated values 43, respectively, for display, and graphically displays the processed displacement amounts on the display device 26 that the computer terminal 201 includes (Step S87).

The user can confirm the contents graphically displayed on the display device 26 and input the information as to whether to use the correction-coefficient calculated values 43 to the input device 27 that the computer terminal 201 includes. The change-agreement confirmation unit 65 determines whether the information to the effect of using the correction-coefficient calculated values 43 is input (Step S88). When the information to the effect of using the correction-coefficient calculated values 43 is not input (NO at Step S88), the change-agreement confirmation unit 65 registers the current correction-coefficient calculated values 48 in the correction coefficient database 63 (Step S89). Thereafter, the user logs out the support site (Step S90), and the operation ends.

When the information to the effect of using the correction-coefficient calculated values 43 is input (YES at Step S88), the change-agreement confirmation unit 65 registers the correction-coefficient calculated values 43 in the correction coefficient database 63 (Step S91), and the file output unit 66 outputs the correction-coefficient calculated values 43 as the new correction-coefficient set values 49 (Step S92). Thereafter, the user downloads the new correction-coefficient set values 49 to the computer terminal 201 (Step S93) and logs out the support site (Step S94). The user transfers the downloaded new correction-coefficient set values 49 to the control device 50 of the electric discharge machine 300 (Step S95).

The correction-coefficient input/output unit 52 receives the transferred new correction-coefficient set values 49, updates the correction-coefficient set values 41 stored in the correction-coefficient set-value storage unit 34 to the new correction-coefficient set values 49 by overwriting the new correction-coefficient set values 49 on the correction-coefficient set values 41 (Step S96), and the operation ends.

In this way, according to the third embodiment of the present invention, the correction coefficient database 63 is configured to accumulate and store therein the correction-coefficient calculated values and the transition of the detected values of the temperature sensors 18a to 18c while associating the correction-coefficient calculated values with the transition of the detected values of the temperature sensors 18a to 18c, and, when a new measurement result that does not include the transition of the displacement amount of the reference position and that includes the transition of the temperature is input, the server 302 searches the correction coefficient database 63 based on the input transition of the temperature, extracts the corresponding correction-coefficient calculated values 43, and outputs the extracted correction-coefficient calculated values 43. Therefore, the user can correct the correction-coefficient set values without measuring the displacement amount.

### INDUSTRIAL APPLICABILITY

As described above, the electric discharge machine and the electric discharge machining system according to the present invention are preferable to be applied for an electric discharge machine and an electric discharge machining system that are capable of executing a positioning control over a machining position.

### REFERENCE SIGNS LIST

10 control device
11 bed
12 work tank wall
13 table
14 main-spindle drive unit
15 main spindle
16 reference electrode
16a to 16e contact position
17 reference ball
18a to 18c temperature sensor
19 display device
20 input device
21 CPU
22 RAM
23 ROM
24 I/F unit
25 control program
26 display device
27 input device
31 temperature/displacement measurement unit
32 correction-coefficient calculation unit
33 confirmation display unit
34 correction-coefficient set-value storage unit
35 change-agreement confirmation unit
36 command-value correction unit
37 command-value generation unit
41 correction-coefficient set value
42 measurement data
43 correction-coefficient calculated value
44 corrected command value
45a, 45b, 46 display screen
47 measurement data file
48 current correction-coefficient set value
49 new correction-coefficient set value
50 control device
51 measurement-data output unit
61 file reception unit
62 correction-coefficient calculation unit
63 correction coefficient database
64 confirmation display unit
65 change-agreement confirmation unit
66 file output unit
70 control device
71 temperature measurement unit
72 measurement-data output unit
81 file reception unit
82 similar-data extraction unit
91 measurement data
92 measurement data file
100, 200, 300 electric discharge machine
201 computer terminal
202, 302 server
203 Internet
460 region
461, 462 touch panel button

1. An electric discharge machine capable of positioning-controlling a machining position, the electric discharge machine comprising:
a temperature sensor that detects an environmental temperature;
a command-value calculation unit that calculates a command value relating to the machining position;
a set-value storage unit that stores therein a correction-coefficient set value;
a command-value correction unit that estimates a displacement amount of a reference position based on a detected value of the temperature sensor and the correction-coefficient set value stored in the set-value storage unit, and that corrects the command value calculated by the command-value calculation unit using the estimated displacement amount; and
a correction unit that corrects the correction-coefficient set value stored in the set-value storage unit, wherein
the correction unit includes
a measurement unit that measures a transition of the displacement amount of the reference position and a transition of the detected value of the temperature sensor,
a correction-coefficient calculation unit that calculates a correction-coefficient calculated value based on a measurement result of the measurement unit,
a confirmation display unit that displays the measurement result of the measurement unit and that prompts to input whether or not to use the correction-coefficient calculated value, and
a setting change unit that updates the correction-coefficient set value stored in the set-value storage unit to the correction-coefficient calculated value when an input to an effect of using the correction-coefficient calculated value is received.

2. The electric discharge machine according to claim 1, wherein the confirmation display unit further displays a comparison of correction effects between the correction-coefficient set value stored in the set-value storage unit and the correction-coefficient calculated value when prompting to input whether or not to use the correction-coefficient calculated value.

3. An electric discharge machining system capable of positioning-controlling a machining position, the electric discharge machining system comprising:
an electric discharge machine including
a temperature sensor that detects an environmental temperature, a command-value calculation unit that calculates a command value relating to the machining position, a set-value storage unit that stores therein a correction-coefficient set value, a command-value correction unit that estimates a displacement amount of a reference position based on a detected value of the temperature sensor and the correction-coefficient set value stored in the set-value storage unit, and that corrects the command value calculated by the command-value calculation unit using the estimated displacement amount, a measurement unit that measures a transition of the displacement amount of the reference position and a transition of the detected value of the temperature sensor, and that outputs a measurement result, and a setting change unit that receives an input of a correction-coefficient calculated value and that updates the correction-coefficient set value stored in the set-value storage unit to the correction-coefficient calculated value; and
a server that includes a data reception unit receiving an input of the measurement result output from the measurement unit, and that calculates and outputs the correction-coefficient calculated value input to the setting change unit based on the input measurement result, wherein
the server includes a database unit accumulating and storing therein the input measurement result or the output correction-coefficient calculated value, and determines, when a new measurement result is input to the data reception unit, whether to output a correction-coefficient set value based on the newly input measurement result based on a storage content of the database unit.

4. The electric discharge machining system according to claim 3, wherein
the data reception unit receives the input of the measurement result output from the measurement unit and the correction-coefficient set value stored in the set-value storage unit, and
the server further includes a confirmation display unit that, when a new measurement result and a new correction-coefficient set value are input to the data reception unit, displays a comparison of correction effects between the input correction-coefficient set value and the correction-coefficient calculated value based on the input measurement result and prompts to input whether to use the correction-coefficient calculated value, and the server determines whether to output the correction-coefficient calculated value based on the newly input measurement result on the basis of the storage content of the database unit and the input as to whether to use the correction-coefficient calculated value.

5. The electric discharge machining system according to claim 4, wherein the server stores the correction-coefficient calculated value based on the newly input measurement result into the database unit when receiving the input to the effect of using the correction-coefficient calculated value, and stores the correction-coefficient set value input together with the newly input measurement result in the data reception unit when receiving the input to the effect of not using the correction-coefficient calculated value.

6. The electric discharge machining system according to claim 3, wherein the server determines whether the correction-coefficient calculated value based on the newly input measurement result is an appropriate value based on a statistic analysis using, as a population, correction-coefficient set values accumulated and stored in the database unit, and determines not to output the correction-coefficient calculated value when determining that the correction-coefficient calculated value is not the appropriate value.

7. The electric discharge machining system according to claim 6, wherein
the database unit accumulates and stores therein the output correction-coefficient calculated value while associating the output correction-coefficient calculated value with the transition of the detected value of the temperature sensor included in the input measurement result, and
when a new measurement result that does not include the transition of the displacement amount of the reference position and that includes the transition of the detected value of the temperature sensor is input to the data reception unit, the server searches the database unit based on the transition of the detected value of the temperature sensor included in the input measurement result, extracts a corresponding correction-coefficient calculated value, and outputs the extracted correction-coefficient calculated value.
